(19) United States
(12) Patent Application Publication
(10) Pub. No.: US 2011/0180626 A1
(43) Pub. Date: Jul. 28, 2011

(54) FOLDABLE EXTENSION PIPE, AND MEASURING WHEEL UNIT AND SPRAYING WHEEL UNIT HAVING THE SAME

(76) Inventor: Dong Hun KANG, Busan (KR)

(21) Appl. No.: 12/902,408

(22) Filed: Oct. 12, 2010

(30) Foreign Application Priority Data
Jan. 27, 2010 (KR) 10-2010-0007414

(51) Int. Cl. B05B 3/02; G01B 7/30; F16L 9/22

(52) U.S. Cl. 239/225.1; 324/207.25; 138/155

(57) ABSTRACT

A foldable extension pipe is provided which consists of upper and lower pipe sections which are folded and unfolded. The operation input from the upper side is transmitted towards the lower side by means of the transmission rods of the upper and lower pipe sections being magnetic-coupled by first and second magnetic couplings. The measuring wheel unit and the spraying wheel unit having the foldable extension pipe are carried or stored with ease, and when a user inputs an operation via the upper portion of the extension pipe, particularly the operation input portion such as an operation lever at the grip portion of the upper portion, the operation output portion manipulates the reset switch of the counter, manipulates the nozzle section of the spray can for spraying paint, or brakes the rotary wheel.

### BACKGROUND OF THE INVENTION

1. Field of the Invention

The present invention relates, in general, to a foldable extension pipe, a measuring wheel unit having the foldable extension pipe which measures a distance by which a rotary wheel rotates, and a spraying wheel unit having the foldable extension pipe which sprays paint onto a path along which a rotary wheel moves.

2. Description of the Related Art

Generally, a measuring wheel unit includes a frame, a rotary wheel rotatably mounted on the frame, a counter mounted on the frame to indicate the distance that the rotary wheel rotates and moves, and an extension pipe provided on the frame and having a grip section on the upper portion.

A conventional spraying wheel unit for spraying paint includes a frame, a rotary wheel rotatably mounted on the frame, a spray can fitting provided on the frame, and an extension pipe provided on the frame and having a grip section on the upper portion.

Also, another type measuring wheel unit was known in which a spray device, configured so that a counter is attached to the rotary wheel of the spraying wheel unit, is combined in the measuring wheel unit in order to spray paint while measuring the distance the rotary wheel moves.

Related technologies were disclosed in the following documents 1 to 8.

### RELATED TECHNOLOGIES

### Patent Documents

Patent Document 1
US patent unexamined publication No. US20070084076 (published on Apr. 19, 2007)
Patent Document 2
US patent unexamined publication No. US20080148591 (published on Jun. 26, 2008)
Patent Document 3
U.S. Pat. No. 4,176,458 (published on Dec. 4, 1979)
Patent document 4
U.S. Pat. No. 7,040,036 (published on May 9, 2006)
Patent document 5
U.S. Pat. No. 7,111,412 (published on Sep. 26, 2006)
Patent document 6
U.S. Pat. No. 7,536,805 (published on May 26, 2009)
Patent document 7
U.S. Pat. No. 7,555,846 (published on Jul. 7, 2009)
Patent document 8
US patent unexamined publication No. US20080256817 (published on Oct. 23, 2008)

In the related art technologies, generally, the lower portion of the extension pipe is coupled to the frame provided adjacent to the ground, and the upper portion thereof has a grip section at the position where a user is ready to grip it while standing up.

The extension pipe has a length much longer than those of the frame and the rotary wheel.

It is therefore preferred that the extension pipe is configured so that a middle portion thereof is folded when the pipe is not used, and the folded middle portion is unfolded when it is used.

The foldable structure of the extension pipe was also known in the art.

It is however preferred that when using the measuring wheel unit and the spraying wheel unit, the extension pipe has a structure in which an input operation is input via the upper portion, particularly, the grip section, a lever, or the like, and then an output operation is output via the frame.

For example, it may be convenient for a user to grab at the grip section, directly manipulate a reset switch of the counter, a nozzle section of the paint can for spraying paint, or a brake lever so that the operating force is transmitted to the rotary wheel to cause it to brake.

### SUMMARY OF THE INVENTION

Accordingly, the present invention has been made keeping in mind the above problems occurring in the related art, and the present invention is to propose a foldable extension pipe, and a measuring wheel unit and a spraying wheel unit which have the foldable extension pipe and are operated by being manipulated at the upper portion of the extension pipe.

In order to achieve the above object, according to one aspect of the present invention, there is provided a measuring wheel unit including a frame, a rotary wheel rotatably mounted on the frame, a counter mounted on the frame to indicate the distance the rotary wheel rotates, and an extension pipe provided on the frame, the extension pipe including: an upper pipe section having a hollow shape; an upper coupling provided on a lower portion of the upper pipe section; a lower coupling having an upper portion hinge-coupled, on one side, to the upper coupling and detachably coupled, on the opposite side, to the upper coupling; a lower pipe section fixed on an upper portion to the lower coupling and on a lower portion to the frame; an upper transmission rod provided in the upper pipe section so as to be movable in the lengthwise direction of the upper pipe section; an operation input portion provided on the upper portion of the upper transmission rod to receive a user's input; a first magnetic coupling provided on the lower portion of the upper transmission rod so as to be placed in the upper coupling; a lower transmission rod provided in the lower pipe section so as to be movable in the lengthwise direction of the lower pipe section; an operation output portion provided on the lower portion of the lower transmission rod; and a second magnetic coupling provided on the upper portion of the lower transmission rod so as to be placed in the lower coupling so that the second magnetic coupling is magnetically coupled with the first magnetic coupling.

According to another aspect of the present invention, there is provided a spraying wheel unit including a frame, a rotary wheel rotatably mounted on the frame, an extension pipe provided on the frame, and a catch so that a spray can is provided on the frame, the extension pipe including: an upper pipe section having a hollow shape; an upper coupling provided on a lower portion of the upper pipe section; a lower coupling having an upper portion hinge-coupled, on one side, to the upper coupling and detachably coupled, on the opposite side, to the upper coupling; a lower pipe section fixed on an upper portion to the lower coupling and on a lower portion to the frame; an upper transmission rod provided in the upper pipe section so as to be movable in the lengthwise direction of the upper pipe section; an operation input portion provided on the upper portion of the upper transmission rod to receive a user's input; a first magnetic coupling provided on the lower portion of the upper transmission rod so as to be placed in the upper coupling; a lower transmission rod provided in the lower pipe section so as to be movable in the lengthwise direction of the lower pipe section; an operation output portion provided on the lower portion of the lower transmission rod; and a second magnetic coupling provided on the upper portion of the lower transmission rod so as to be placed in the lower coupling so that the second magnetic coupling is magnetically coupled with the first magnetic coupling.

In an exemplary embodiment, a counter may be further provided on the frame to indicate the distance the rotary wheel rotates over.

According to a further aspect of the present invention, there is provided a foldable extension pipe including: an upper pipe section having a hollow shape; an upper coupling provided on a lower portion of the upper pipe section; a lower coupling having an upper portion hinge-coupled, on one side, to the upper coupling and detachably coupled, on an opposite side, to the upper coupling; a lower pipe section fixed on an upper portion to the lower coupling; an upper transmission rod provided in the upper pipe section so as to be movable in the lengthwise direction of the upper pipe section; an operation input portion provided on the upper portion of the upper transmission rod to receive a user's input; a first magnetic coupling provided on the lower portion of the upper transmission rod so as to be placed in the upper coupling; a lower transmission rod provided in the lower pipe section so as to be movable in the lengthwise direction of the lower pipe section; an operation output portion provided on the lower portion of the lower transmission rod; and a second magnetic coupling provided on the upper portion of the lower transmission rod so as to be placed in the lower coupling so that the second magnetic coupling is magnetically coupled with the first magnetic coupling.

In an exemplary embodiment, at least one of the first and second magnetic couplings may be a magnet.

In an exemplary embodiment, the operation output portion may be a brake member for braking the rotary wheel, a manipulating portion for manipulating a reset switch of the counter, or a manipulating portion for manipulating the spray can which is for spraying paint.

According to the construction of the present invention, while the extension pipe consists of upper and lower pipe sections which can be folded and unfolded, the operation occurring on the upper side can be transmitted towards the lower side by means of the transmission rods of the upper and lower pipe sections being magnetic-coupled by the first and second magnetic couplings.

Thus, the measuring wheel unit and the spraying wheel unit can be carried or stored with ease, and when a user inputs an operation via the upper portion of the extension pipe, particularly the operation input portion such as an operation lever at the grip portion of the upper portion, the operation output portion can manipulate the reset switch of the counter, manipulate the nozzle section of the spray can which is for spraying paint, or brake the rotary wheel.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a cross-sectional view explaining the basic concept of an extension pipe of the invention;

FIG. 2 is a cross-sectional view showing the extension pipe of FIG. 1 being folded;

FIG. 3 is a view showing the operation of the extension pipe of FIG. 1;

FIG. 4 is a view showing a modified example of the extension pipe of FIG. 1;

FIG. 5 is a view showing the operation of the extension pipe of FIG. 4;

FIG. 6 is a view showing another modified example of the extension pipe of FIG. 1;

FIG. 7 is a perspective view showing a spraying wheel unit according to an embodiment of the invention;

FIG. 8 is a perspective view showing the spraying wheel unit of FIG. 7 being folded;

FIG. 9 is a cross-sectional perspective view showing the major parts of the spraying wheel unit of FIG. 7;

FIG. 10 is a cross-sectional perspective view showing the major parts of the spraying wheel unit of FIG. 8;

FIG. 11 is a view showing the operation of the major parts shown in FIG. 9;

FIG. 12 is a perspective view showing a measuring wheel unit according to an embodiment of the invention;

FIG. 13 is a perspective view showing the measuring wheel unit of FIG. 12 being folded;

FIG. 14 is a cross-sectional perspective view showing the major parts of the measuring wheel unit of FIG. 12; and

FIG. 15 is a view showing the operation of the measuring wheel unit of FIG. 14.

### DETAILED DESCRIPTION OF THE INVENTION

Reference will now be made in greater detail to a preferred embodiment of the invention with reference to the accompanying drawings such that the skilled persons in the art can implement the invention with ease. The invention however is not limited thereto, but may be implemented in a variety of different forms. In the drawings, the portions that are irrelevant to those parts described were omitted, and the same reference numerals will be used throughout the drawings and the description to refer to the same or like parts.

In the specification, the term, “have”, “include”, or “comprise” is not exclusive but inclusive term especially if not otherwise designated.

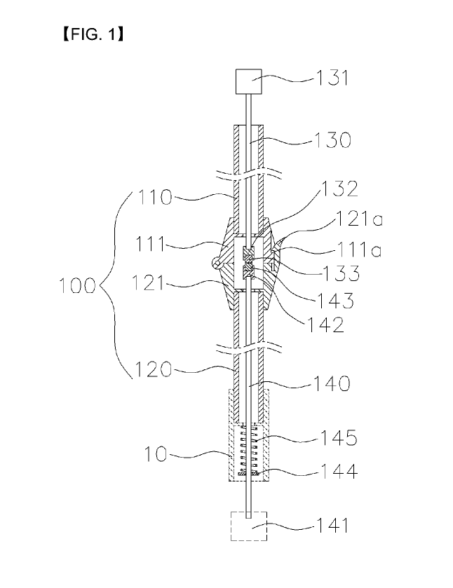

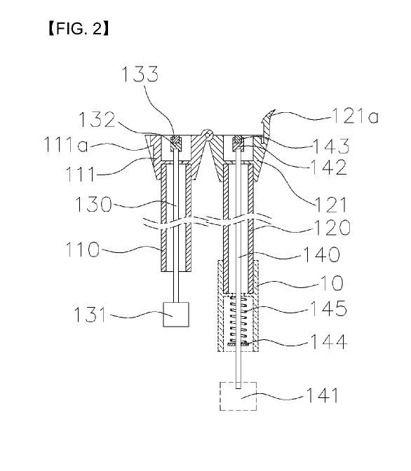

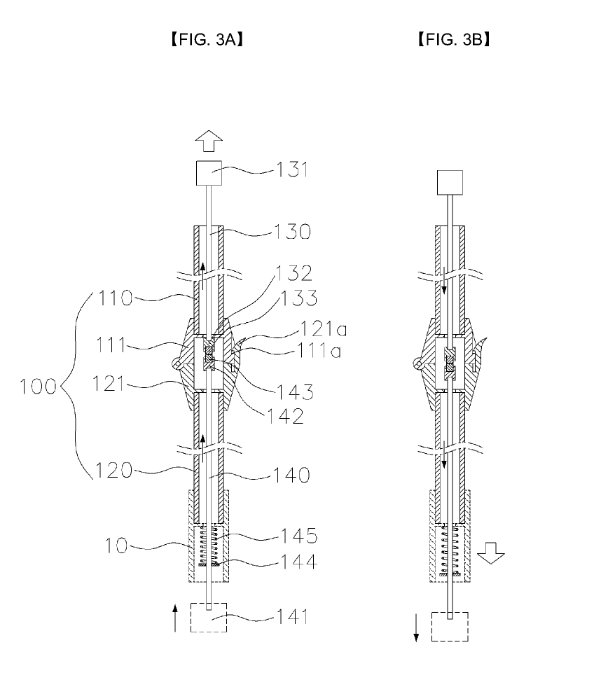

FIG. 1 is a cross-sectional view explaining the basic concept of an extension pipe of the invention, FIG. 2 is a cross-sectional view showing the extension pipe of FIG. 1 being folded, and FIG. 3 is a view showing the operation of the extension pipe of FIG. 1.

The foldable extension pipe 100 is configured so that an upper pipe section 110 and a lower pipe section 120 are coupled with each other by means of an upper coupling 111 and a lower coupling 121.

The upper and lower pipe sections 110 and 120 are of the shape of a linear hollow pipe.

The upper coupling 111 is provided on the lower portion of the upper pipe section 110, and the lower coupling 121 is provided on the upper portion of the lower pipe section 120.

The lower coupling 121 is coupled with the upper coupling 111 such that one side is hinged to the upper coupling 111 and an opposite side is detachably coupled with the upper coupling 111.

To this end, the lower coupling 121 is provided on the opposite side with a locking protrusion 121a, and the upper coupling 111 is provided on the corresponding portion with a locking step 111a. Thus, when the locking protrusion 121a of the lower coupling 121 is engaged on and fastened to the locking step 111a of the upper coupling 111, the upper and lower pipe sections 110 and 120 are connected in a linear manner as shown in FIG. 1. Further, when the upper and lower couplings 111 and 121 are disengaged from each other by pulling out the locking protrusion 121a of the lower coupling 121 from the locking step of the upper coupling, the upper pipe section 110 becomes foldable relative to the lower pipe section 120 as shown in FIG. 2.

An upper transmission rod 130 is provided in the upper pipe section 110 such that it passes through the upper pipe section. Further, a lower transmission rod 140 is provided in the lower pipe section 120 such that it passes through the lower pipe section.

The upper and lower transmission rods 130 and 140 are respectively movable in the lengthwise directions of the upper pipe section 110 and the lower pipe section 120.

An operation input portion 131 is provided on the upper portion of the upper transmission rod 130.

The operation input portion 131 may be of any shape such as those of a button, the trigger of a gun, or the like, so long as it can receive the user's input action (pushing or pulling).

The upper transmission rod 130 is provided on the lower portion with a first magnetic coupling 133 housed in a first magnet storage 132.

The first magnet storage 132 and the first magnetic coupling 133 are provided in the upper coupling 111 so that they are movable in a vertical direction together with the upper transmission rod 130.

The lower transmission rod 140 is provided on the lower portion with an operation output portion 141.

The operation output portion 141 is a section for carrying out a specific operation, such as braking the rotary wheel, manipulating a reset switch of a counter, or manipulating a spray can for spraying paint.

The operation output portion 141 is driven by the vertical movement of the lower transmission rod 140. The operation output portion may be reciprocated on the line, or be rotatable using a cam or the like.

The lower transmission rod 140 is provided on the upper portion with a second magnetic coupling 143 housed in a second magnet storage 142.

The second magnet storage 142 and the second magnetic coupling 143 are provided in the lower coupling 121 so that they are movable in a vertical direction together with the lower transmission rod 140.

The first and second magnetic couplings 133 and 143 can be magnetically coupled with each other.

The first and second magnetic couplings 133 and 143 are both preferably magnets. However, it may be configured so that either one is a magnet and the other is a metal which can be magnetically attached to the magnet.

The first and second magnetic couplings 133 and 143 become decoupled when the foldable extension pipe 100 is folded as shown in FIG. 2.

Meanwhile, the lower portion of the lower pipe section 120 is coupled to the frame 10, and a lower transmission rod 140 extends to the inside of the frame 10 through the lower pipe section 120.

The lower transmission rod 140, provided in the frame, is provided with a stopper 144, and a restoring spring 145 is provided between the stopper 144 and the frame 10.

Thus, when the operation input portion is pulled up as shown in (a) of FIG. 3, the upper transmission rod 130 is pulled up, the lower transmission rod 140 is pulled up by means of the first and second magnetic couplings 133 and 143, and finally the operation output portion 141 is operated.

Further, when the force applied to the operation input portion 131 is removed, the upper and lower transmission rods 130 and 140 return to their original states and thus move towards the lower side by means of the elastic force of the restoring spring 145 as shown in (b) of FIG. 3.

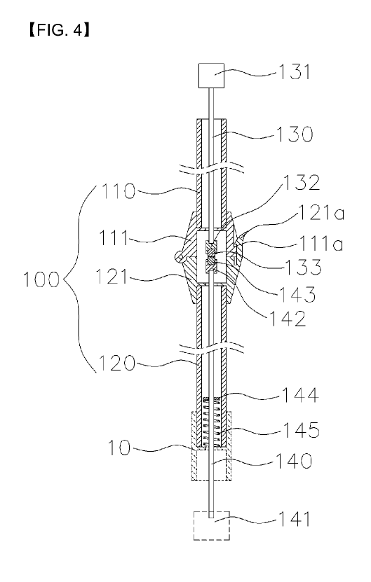

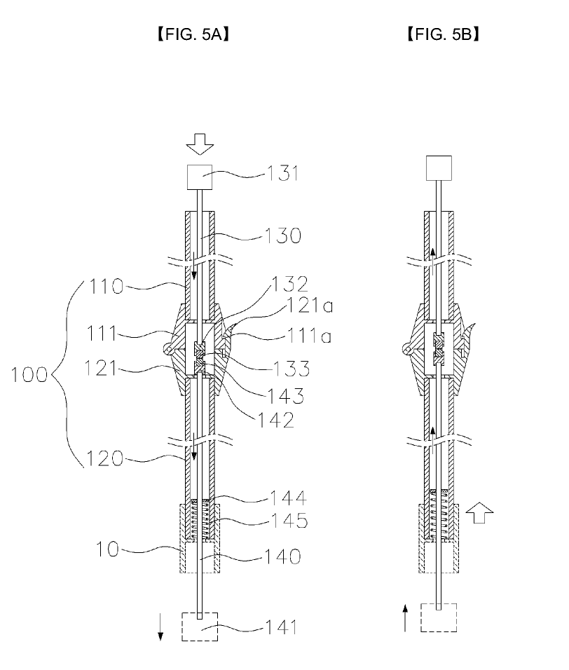

FIG. 4 is a view showing a modified example of the extension pipe of FIG. 1, and FIG. 5 is a view showing the operation of the extension pipe of FIG. 4.

While the operation input portion 131 of FIG. 1 can be pulled up, the operation input portion 131 of FIG. 4 can be pushed down.

A difference between FIGS. 4 and 1 is that the positions of the stopper 144 and the restoring spring 145 are different.

When the operation input portion 131 is pushed down as shown in (a) of FIG. 5, the upper transmission rod 130 is pushed down, the lower transmission rod 140 is pushed down by means of the first and second magnetic couplings 133 and 143, and finally the operation output portion 141 is operated.

Further, when the force applied to the operation input portion 131 is removed, the upper and lower transmission rods 130 and 140 return to their original states and thus move towards the upper side by means of the elastic force of the restoring spring 145 as shown in (b) of FIG. 5.

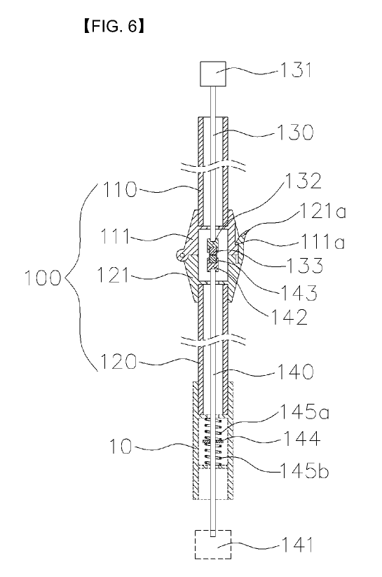

FIG. 6 is a view showing another modified example of the extension pipe of FIG. 1, wherein pulling-up and pushing-down both are applicable.

In FIG. 6, in order to allow the upper and lower transmission rods 130 and 140 to return to their original positions even when either pulling-up or pushing-down is applied, two restoring springs 145a and 145b are provided with the stopper 144 disposed therebetween.

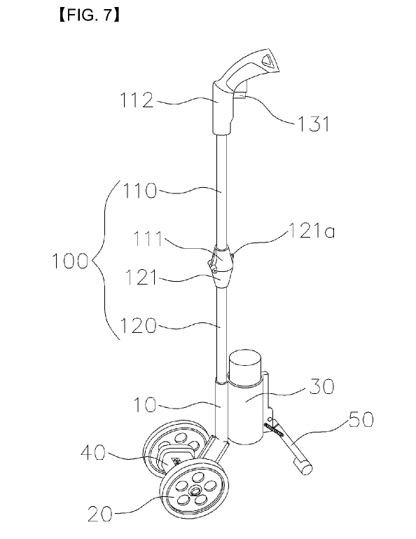

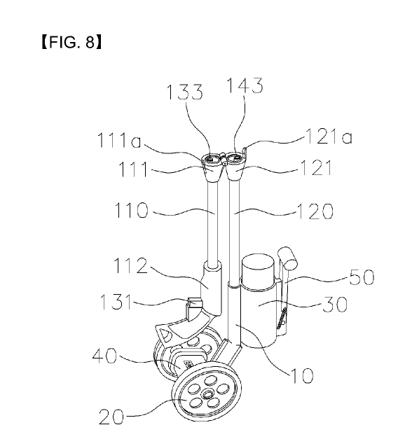

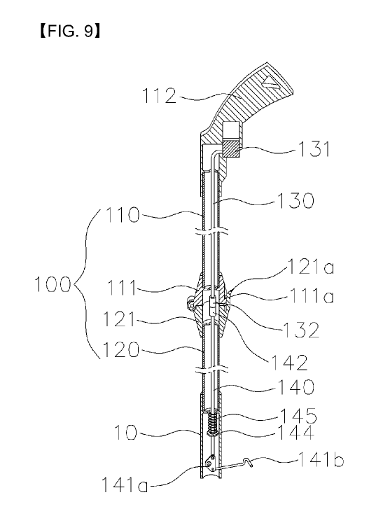

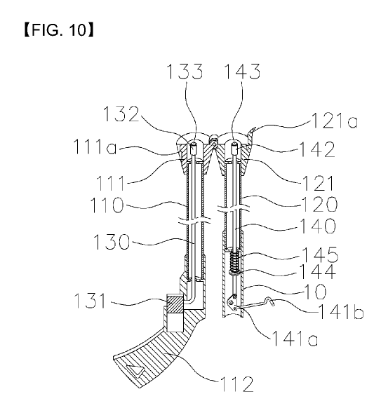

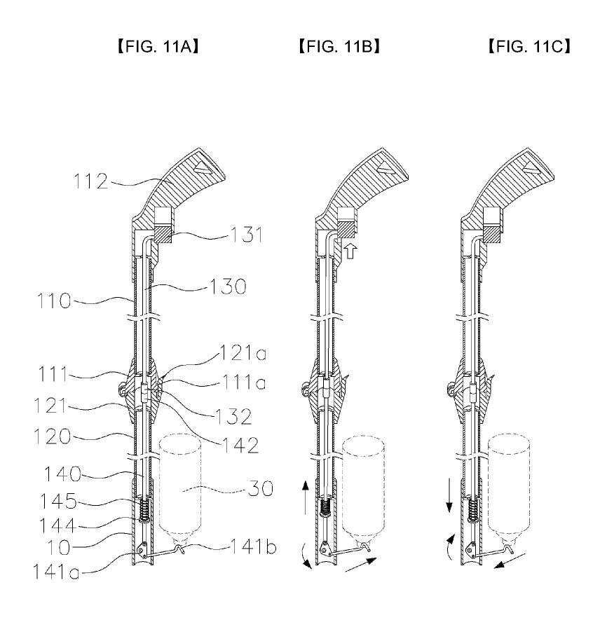

FIG. 7 is a perspective view showing a spraying wheel unit according to an embodiment of the invention, FIG. 8 is a perspective view showing the spraying wheel unit of FIG. 7 being folded, FIG. 9 is a cross-sectional perspective view showing the major parts of the spraying wheel unit of FIG. 7, FIG. 10 is a cross-sectional perspective view showing the major parts of the spraying wheel unit of FIG. 8, and FIG. 11 is a view showing the operation of the major parts shown in FIG. 9.

As shown in FIG. 7, the spraying wheel unit includes a frame 10, a rotary wheel 20 rotatably mounted on the frame 10, an extension pipe 100 mounted on the frame 10, a grip section 112 provided on an upper portion of the extension pipe 100, and a catch 30 for a spray can which is for spraying paint, the catch being provided on the frame 10. Unexplained reference numeral 50 denotes a stand.

The spraying wheel unit includes a counter 40 which is provided on the frame 10 to indicate a distance through which the rotary wheel 20 rotates, so that it can spray paint the ground and display the line on the ground while measuring the moving distance of the rotary wheel 20 while rotating.

The spraying wheel unit can be erected as shown in FIG. 7, and can spray paint on the ground while moving with the stand 50 folded. Further, the spraying wheel unit can be carried or stored as shown in FIG. 8, so that the volume thereof can be made compact.

As shown in FIGS. 9 to 11, the spraying wheel unit is configured so that the trigger type operation input portion 131 is pulled up, and the operation output portion 141 can spray paint by the action of the upper movement of the lower transmission rod 140 which presses the nozzle of the spray can.

To this end, the operation output portion 141 is configured so that the lower portion of the lower transmission rod 140 is hinge-coupled thereto, and a cam 141a rotatably provided on the frame 10 and an operation bar 141b connected to one side of the cam 141a form a manipulating section for the spray can.

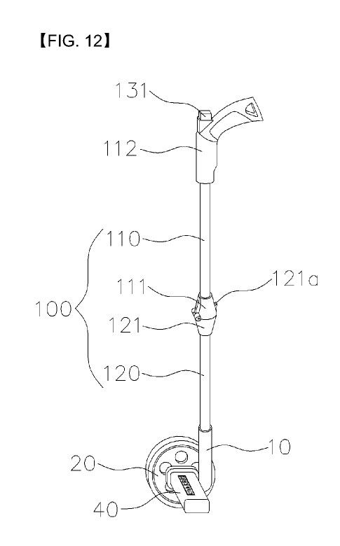

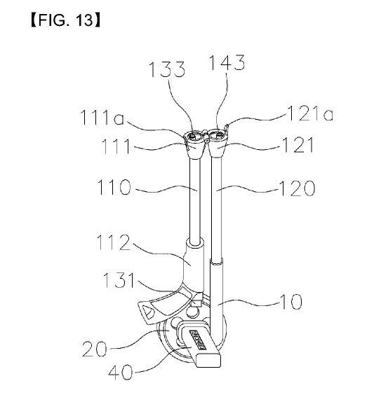

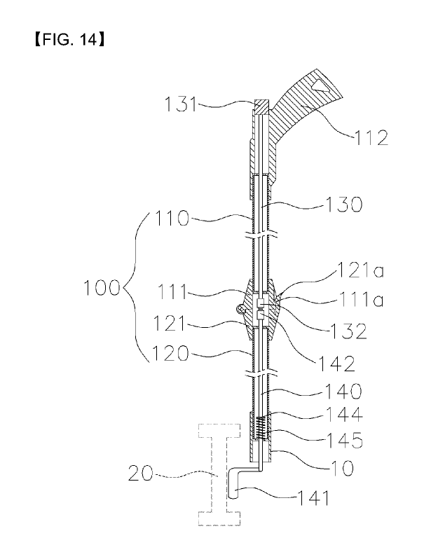

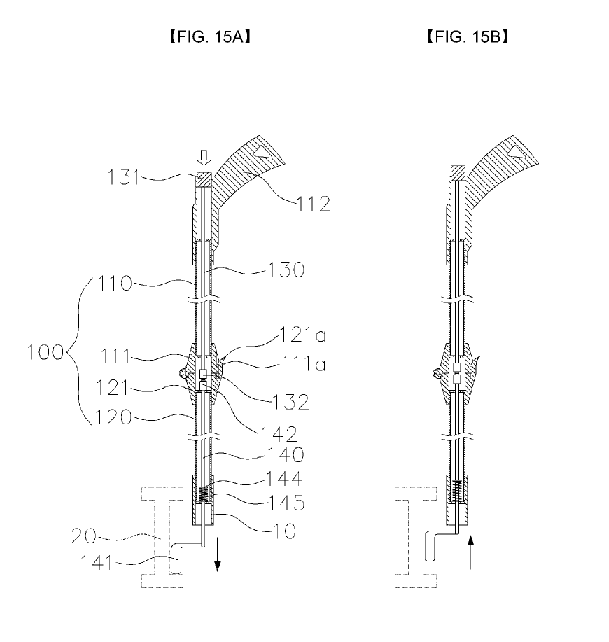

FIG. 12 is a perspective view showing a measuring wheel unit according to an embodiment of the invention, FIG. 13 is a perspective view showing the measuring wheel unit of FIG. 12 being folded, FIG. 14 is a cross-sectional perspective view showing the major parts of the measuring wheel unit of FIG. 12, and FIG. 15 is a view showing the operation of the measuring wheel unit of FIG. 14.

As shown in FIG. 12, the measuring wheel unit includes a frame 10, a rotary wheel 20 rotatably mounted on the frame 10, an extension pipe 100 mounted on the frame 10, a grip section 112 provided on the upper portion of the extension pipe 100, and a counter provided on the frame 10 to indicate a moving distance of the rotary wheel 20 during rotation.

The measuring wheel unit indicates the moving distance of the rotary wheel 20, which is rolled over the ground, using the counter 40.

The measuring wheel unit can be used in the state shown in FIG. 12, and can be carried and stored in the state shown in FIG. 13, so that the volume thereof can be made compact.

As shown in FIGS. 14 and 15, the measuring wheel unit is configured so that the operation input portion 131 is pushed down, and the operation output portion 141 is a brake member that brakes the rotary wheel 20 through the downward movement of the lower transmission rod 140.

When the operation input portion 131 is pushed down or pressed down as shown in (a) of FIG. 15, the operation output portion 141, the brake member, moves down to contact and brake the rotary wheel 20. Further, when the force applied to the operation input portion 131 is removed, the operation output portion returns to its original position by means of the restoring spring 145 as shown in (b) of FIG. 15.

While the operation output portion 141 is described as being embodied as the brake member or the manipulating section for the spray can, the operation output portion 141 may be embodied as a manipulating section for a reset switch of the counter 40.

As set forth before, the invention is applicable to the measuring wheel unit which is for measuring the moving distance of the rotary wheel while it rotates, and the spraying wheel unit which is for spraying paint along a path on which the rotary wheel moves.

It is understood that the description is merely for illustrative purposes and the skilled persons in the art can modify the invention into other forms with ease without changing the technical scope and essential features of the invention. Thus, it should be construed that the described embodiments are not restrictive, but merely illustrative. For example, the single-type elements may be realized in a decentralized form, and the decentralized type elements may be formed in combined types.

The scope of the invention is disclosed in the accompanying claims rather than the description, and it is construed that the meaning and the scope of the claims, and all changes induced from the equivalence thereof are included in the scope of the invention.

What is claimed is:

1. A measuring wheel unit comprising: a frame; a rotary wheel rotatably mounted on the frame; a counter mounted on the frame to indicate a rotating distance of the rotary wheel; and an extension pipe provided on the frame,
the extension pipe including:
an upper pipe section having a hollow shape;
an upper coupling provided on a lower portion of the upper pipe section;
a lower coupling having an upper portion hinge-coupled, on one side, to the upper coupling and detachably coupled, on an opposite side, to the upper coupling;
a lower pipe section fixed, on an upper portion, to the lower coupling and, on a lower portion, to the frame;
an upper transmission rod provided in the upper pipe section so as to be movable in a lengthwise direction of the upper pipe section;
an operation input portion provided on the upper portion of the upper transmission rod to receive a user's input;
a first magnetic coupling provided on the lower portion of the upper transmission rod so as to be placed in the upper coupling;
a lower transmission rod provided in the lower pipe section so as to be movable in a lengthwise direction of the lower pipe section;
an operation output portion provided on the lower portion of the lower transmission rod; and
a second magnetic coupling provided on the upper portion of the lower transmission rod so as to be placed in the lower coupling so that the second magnetic coupling is magnetically coupled with the first magnetic coupling.

2. A spraying wheel unit comprising: a frame; a rotary wheel rotatably mounted on the frame; an extension pipe provided on the frame; and a catch for a spray can provided on the frame,
the extension pipe including:
an upper pipe section having a hollow shape;
an upper coupling provided on a lower portion of the upper pipe section;
a lower coupling having an upper portion hinge-coupled, on one side, to the upper coupling and detachably coupled, on an opposite side, to the upper coupling;
a lower pipe section fixed, on an upper portion, to the lower coupling and, on a lower portion, to the frame;
an upper transmission rod provided in the upper pipe section so as to be movable in a lengthwise direction of the upper pipe section;
an operation input portion provided on the upper portion of the upper transmission rod to receive a user's input;
a first magnetic coupling provided on a lower portion of the upper transmission rod so as to be placed in the upper coupling;
a lower transmission rod provided in the lower pipe section so as to be movable in the lengthwise direction of the lower pipe section;
an operation output portion provided on a lower portion of the lower transmission rod; and
a second magnetic coupling provided on an upper portion of the lower transmission rod so as to be placed in the lower coupling so that the second magnetic coupling is magnetically coupled with the first magnetic coupling.

3. The spraying wheel unit according to claim 2, wherein a counter is further provided on the frame to indicate a rotating distance of the rotary wheel.

4. A foldable extension pipe comprising:
an upper pipe section having a hollow shape;
an upper coupling provided on a lower portion of the upper pipe section;
a lower coupling having an upper portion hinge-coupled, on one side, to the upper coupling and detachably coupled, on an opposite side, to the upper coupling;
a lower pipe section fixed, on an upper portion, to the lower coupling;
an upper transmission rod provided in the upper pipe section so as to be movable in a lengthwise direction of the upper pipe section;
an operation input portion provided on an upper portion of the upper transmission rod to receive a user's input;
a first magnetic coupling provided on a lower portion of the upper transmission rod so as to be placed in the upper coupling;
a lower transmission rod provided in the lower pipe section so as to be movable in a lengthwise direction of the lower pipe section;
an operation output portion provided on the lower portion of the lower transmission rod; and
a second magnetic coupling provided on an upper portion of the lower transmission rod so as to be placed in the lower coupling so that the second magnetic coupling is magnetically coupled with the first magnetic coupling.

5. The foldable extension pipe according to claim 4, wherein at least one of the first and second magnetic couplings is a magnet.

6. The foldable extension pipe according to claim 5, wherein the operation output portion is a brake member for braking the rotary wheel.

7. The foldable extension pipe according to claim 5, wherein the operation output portion is a manipulating portion for manipulating a reset switch of the counter.

8. The foldable extension pipe according to claim 5, wherein the operation output portion is a manipulating portion for manipulating the spray can which is for spraying paint.
